(19) United States
(12) Patent Application Publication
(10) Pub. No.: US 2006/0100885 A1
(43) Pub. Date: May 11, 2006

(54) Method and apparatus to encode and decode an audio signal

(76) Inventor: Yoon-hark Oh, Suwon-si (KR)

Correspondence Address: STANZIONE & KIM, LLP, 919 18TH STREET, N.W., SUITE 440, WASHINGTON, DC, 20006, US

(21) Appl. No.: 11/144,945

(22) Filed: Jun. 6, 2005

(30) Foreign Application Priority Data
Oct. 26, 2004 (KR) 2004-85806

(51) Int. Cl. G10L 21/04

(52) U.S. Cl. 704/503

(57) ABSTRACT

An audio encoding/decoding method and apparatus to reproduce a high quality audio signal without losing a high frequency band using time-scale compression/expansion. The method includes encoding an input audio signal into audio data by determining a similarity between frames of the input audio signal, compressing the input audio signal with respect to a time-scale, generating a frame time-scale modification flag, and decoding the audio data of the encoded audio signal based on the frame time-scale modification flag.

### CROSS-REFERENCE TO RELATED APPLICATIONS

This application claims priority from Korean Patent Application No. 2004-85806, filed on Oct. 26, 2004, in the Korean Intellectual Property Office, the disclosure of which is incorporated herein in its entirety by reference.

### BACKGROUND OF THE INVENTION

1. Field of the Invention

The present general inventive concept relates to an audio coder/decoder (codec), and more particularly, to an audio encoding/decoding method and apparatus, which can reproduce a high quality audio signal without losing a high frequency band, using time-scale compression/expansion.

2. Description of the Related Art

Moving Picture Experts Group—1 (MPEG-1) is a standard related to digital video and audio compression, which is supported by the International Organization for Standardization (ISO). MPEG-1 audio is used for compressing an audio signal with a 44.1 KHz sampling rate, as is stored on a CD having 60 to 72 minutes capacity, and is divided into three layers based on compression method and codec complexity.

Of the three layers, layer 3 is the most complicated, since it uses many more filters than layer 2 and uses the Huffman coding scheme. Additionally, in layer 3, sound quality depends on the encoding bitrate (112 kb/s, 128 kb/s, 160 kb/s, etc.). MPEG-1 layer 3 audio is typically called “MP3” audio.

An MP3 audio signal is encoded by bit allocation and quantization using a discrete cosine transformer (DCT) having filter banks and a psychoacoustic model.

However, if the MP3 audio signal is heavily compressed, its high frequency band may be lost or discarded. For example, in a 96 kb/s MP3 file, frequency components of more than 11.025 kHz within 32 filter bank values are lost. In a 128 kb/s MP3 file, frequency components of more than 15 kHz within 32 filter bank values are lost. Since human hearing is generally less sensitive to some high frequency components, the high frequency band is sometimes discarded in order to compress the audio signal into the MP3 format. However, this high frequency band loss changes the tone and degrades the clarity of sound, giving a dull, suppressed output sound.

### SUMMARY OF THE INVENTION

The present general inventive concept provides an audio encoding/decoding method which can reproduce a high quality audio signal without losing a high frequency band using time-scale compression/expansion.

The present general inventive concept also provides an audio encoding/decoding apparatus that can perform the audio encoding/decoding method.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an audio encoding/decoding method comprising encoding an input audio signal into audio data by determining a similarity between frames of the input audio signal, compressing the input audio signal on a time-scale, generating a frame time-scale modification flag, and decoding the audio data from the encoded audio signal based on the frame time-scale modification flag.

The foregoing and/or other aspects and advantages of the present general inventive concept are also achieved by providing an audio encoding/decoding apparatus comprising a pre-processor to compress an input audio signal on a time-scale based on a similarity between frames of the input audio signal and to generate a frame time-scale modification flag accordingly, an encoder to encode the compressed audio signal into audio data based on a psychoacoustic model, a packing unit to convert the frame time-scale modification flag generated by the pre-processor and the audio data encoded by the encoder into a bitstream, an unpacking unit to separate the frame time-scale modification flag and the audio data from the bitstream received from the packing unit, a decoder to decode the audio data separated by the unpacking unit into a decoded audio signal using a predetermined decoding algorithm, and a post-processor to expand the audio signal decoded by the decoder by expanding the time-scale when the frame time-scale modification flag separated by the unpacking unit is enabled.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an audio encoding apparatus according to an embodiment of the present general inventive concept;

FIG. 2A illustrates a pre-processor of the audio encoding apparatus of FIG. 1 according to an embodiment of the present general inventive concept;

FIG. 2B illustrates a pre-processor of the audio encoding apparatus FIG. 1 according to another embodiment of the present general inventive concept;

FIG. 3 illustrates an encoder of the audio encoding apparatus of FIG. 1;

FIG. 4 is a block diagram illustrating an audio decoding apparatus according to an embodiment of the present general inventive concept;

FIG. 5 illustrates a post-processor of the audio decoding apparatus of FIG. 4;

FIG. 6 illustrates a decoder of the audio decoding apparatus of FIG. 4

FIG. 7 is a flowchart illustrating a method of determining frame similarity according to an embodiment of the present general inventive concept; and

FIGS. 8A through 8C are waveform diagrams illustrating a method of modifying a time-scale according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

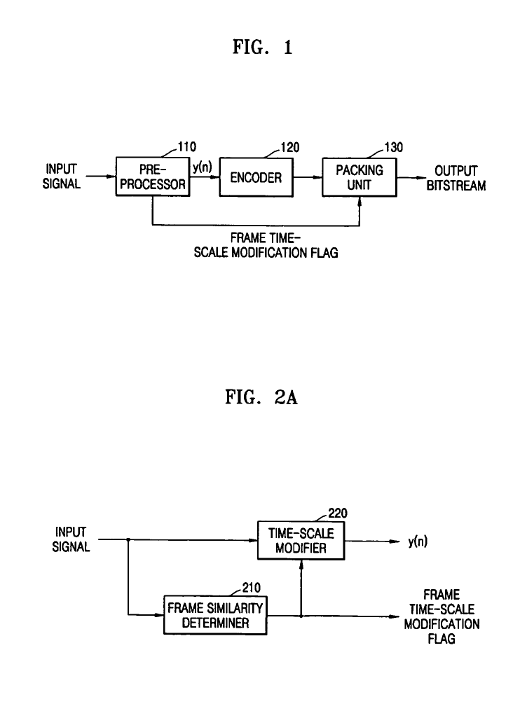

FIG. 1 is a block diagram illustrating an audio encoding apparatus according to an embodiment of the present general inventive concept.

Referring to FIG. 1, a pre-processor 110 determines a similarity between frames of an input audio signal, modifies a corresponding frame audio signal on a time-scale if the similarity is greater than a predetermined value, and generates a frame time-scale modification flag.

An encoder 120 encodes the audio signal that is pre-processed by the pre-processor 110 into audio data based on a psychoacoustic model.

A packing unit 130 constructs a signal output stream (i.e., a bitstream) according to the frame time-scale modification flag generated by the pre-processor 110 and the audio data encoded by the encoder 120.

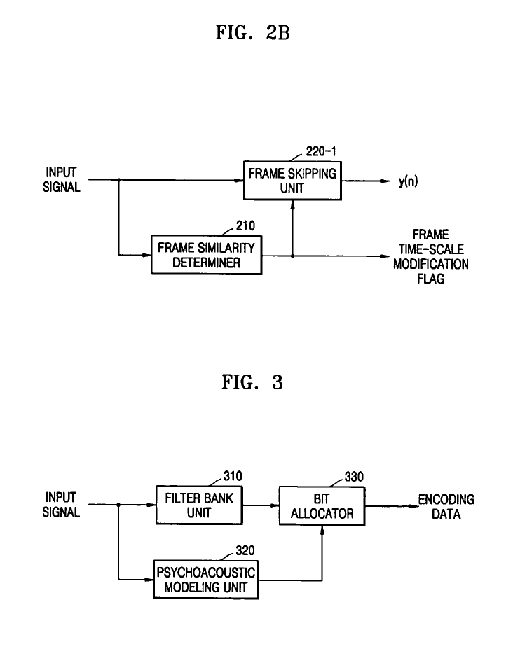

FIG. 2A illustrates the pre-processor 110 of FIG. 1 according to an embodiment of the present general inventive concept.

Referring to FIG. 2A, a frame similarity determiner 210 analyzes a frequency component for each frame of an input signal and determines the similarity between frames based on a difference between frequency components of the respective frames. The frame similarity determiner 210 generates a frame time-scale modification flag if the similarity between a previous frame and a current frame is greater than a predetermined value.

A time-scale modifier 220 modifies a corresponding frame on the time-scale according to whether the frame similarity determiner 210 generates the frame time-scale modification flag.

FIG. 2B illustrates the pre-processor 110 of FIG. 1 according to another embodiment of the present general inventive concept.

Referring to FIG. 2B, the frame similarity determiner 210 generates a frame skip flag if the similarity between a previous frame and a current frame is greater than a predetermined value.

A frame skip unit 220-1 skips a current frame according to whether the frame skip flag is generated by the frame similarity determiner 210. The frame skip flag notifies the frame skipping unit 220-1 that the current frame should not be encoded, since it is similar to the previous frame. The frame skip flag is then packed into the bitstream by the packing unit 130 (see FIG. 1) along with the encoded audio data to inform a decoding apparatus that the current frame has been skipped during the encoding process. Accordingly, the decoding apparatus can then use data of the previous frame to derive data of the current frame.

FIG. 3 illustrates the encoder 120 of FIG. 1.

Referring to FIG. 3, a filter bank unit 310 band-splits pulse code modulated (PCM) audio samples input in each granule unit into 32 subbands using polyphase banks. Additionally, each subband is transformed into 18 spectral coefficients by a modified discrete cosine transformation (MDCT).

A psychoacoustic modeling unit 320 determines bit allocation information for each subband using a masking effect and an audible limitation discovered using psychoacoustics. Psychoacoustics relies on human acoustic perception characteristics of sound. For example, a frequency component of a high level masks a frequency component of a low level. Thus, the frequency component of the low level can be encoded with less accuracy by using a smaller number of bits (or no bits at all).

A bit allocator 330 allocates bits to filter bank subbands or spectral coefficients split by the filter bank unit 310, using the bit allocation information for each filter bank subbands determined based on a psychoacoustic model of the psychoacoustic modeling unit 320.

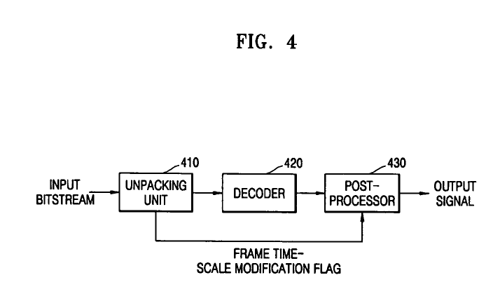

FIG. 4 is a block diagram illustrating an audio decoding apparatus according to an embodiment of the present general inventive concept.

Referring to FIG. 4, an unpacking unit 410 receives a bitstream and separates a frame time-scale modification flag, header information, side information, and main data bits of encoded audio data.

A decoder 420 restores an MDCT or filter bank component with respect to the main data bits separated by the unpacking unit 410, and generates an audio signal by performing an inverse MDCT, or by performing an inverse filtering of the MDCT or filter bank component.

A post-processor 430 expands the audio signal decoded by the decoder 420 by performing a time-scale expansion, if the frame time-scale modification flag received from the unpacking unit 410 is enabled. In other words, the frame time-scale modification flag informs the post processor 430 when a corresponding frame of the decoded audio signal has been time frame modified (i.e., compressed) during a previous encoding process such that the post processor 430 can re-modify (i.e., expand) the corresponding frame to obtain the original audio signal.

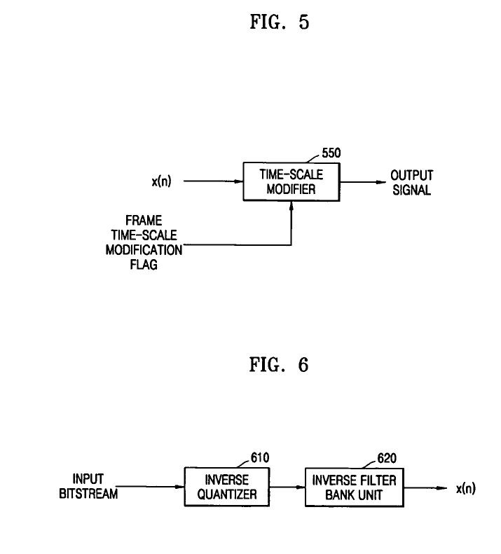

FIG. 5 illustrates an example of the post-processor 430 of FIG. 4.

Referring to FIG. 5, a time-scale modifier 550 expands an audio signal x(n) decoded by the decoder 420 by performing a time-scale expansion according to whether a frame time-scale modification flag is received.

FIG. 6 illustrates an example of the decoder 420 of FIG. 4.

Referring to FIG. 6, an inverse quantizer 610 restores an MDCT or filter bank component by inverse-quantizing the unpacked main data bits.

An inverse filter bank unit 620 generates an audio signal x(n) by performing an inverse MDCT, or by performing an inverse filter banking of the restored MDCT or filter bank component.

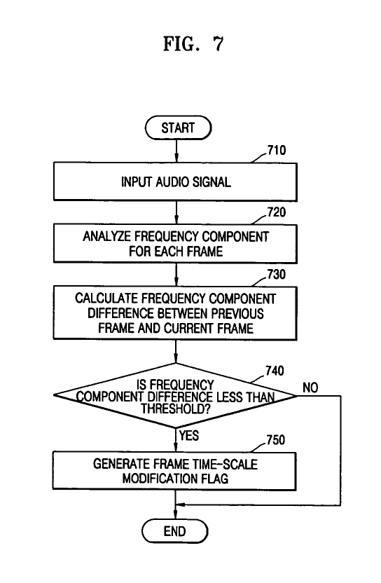

FIG. 7 is a flowchart illustrating a method of determining a frame similarity by the frame similarity determiner 210 according to an embodiment of the present general inventive concept. In some embodiments of the present general inventive concept, the method may be performed by the pre-processor 110 of FIGS. 2A and 2B.

An audio signal is input in operation 710.

A frequency component of the input audio signal is analyzed in frame units (i.e., for each frame in the input audio signal) using a FFT (fast Fourier transform) in operation 720.

An analyzed frequency component difference between a previous frame and a current frame is calculated in operation 730.

If the analyzed frequency component difference is less than or equal to a predetermined threshold, in operation 740, it is determined that a similarity exists between the previous frame and the current frame, and a frame time-scale modification flag is generated in operation 750. If the analyzed frequency component difference is greater than the predetermined threshold, it is determined that no similarity exists between the previous frame and the current frame, and the frame time-scale modification flag is not generated.

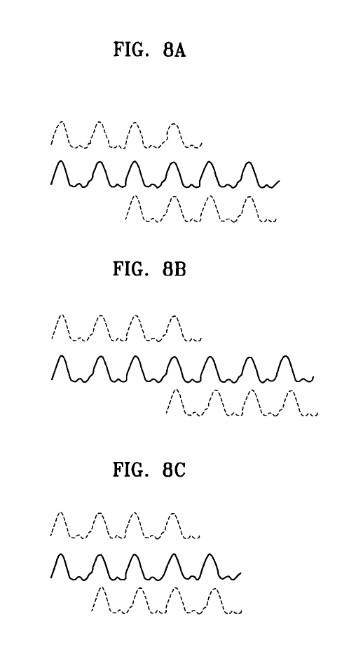

FIGS. 8A through 8C are waveform diagrams illustrating a method of modifying a time-scale. In some embodiments, the method may be applied by the pre-processor 110 of FIGS. 2A and 2B and the post-processor 430 of FIG. 4 to compress or expand an audio signal with respect to the time scale, respectively.

Time-scale modification refers to a change in a signal reproduction rate. The time-scale modification modifies the signal reproduction rate without changing a pitch of an output audio signal.

The time-scale modification involves two main operations: a time-scale compression (an increase of the signal reproduction rate) and a time-scale expansion (a decrease of the signal reproduction rate). The time-scale compression is performed by deleting a pitch duration, and the time-scale expansion is performed by inserting additional pitch durations. The pitch duration that is deleted and inserted may exist in or correspond to a frame of the input audio signal. In general, a synchronized overlap and add (SOLA) method has excellent performance and can be used to delete and/or insert the pitch duration.

The SOLA method uses a cross-correlation coefficient that enables the time-scale modification in a time domain without using an FFT.

A SOLA function operates regardless of a signal pitch. That is, an input signal has a fixed length and is transmitted by dividing the input signal into a plurality of windows. Here, the fixed length should have at least 2 to 3 pitch durations.

An output signal is synthesized by overlapping and adding the pitch durations of the input signal.

It is assumed that x(n) denotes the input signal and y(n) denotes a time-scale modified signal (i.e., the synthesized signal). Also, it is assumed that N denotes a length of a frame, Sₐ denotes a gap between frames of the input signal x(n), and Sₛ denotes a gap between frames of the time-scale modified signal y(n). A modification ratio a is obtained by Sₛ/Sₐ. Here, if a is greater than 1, the time-scale modification corresponds to time-scale compression, and if a is less than 1, the time-scale modification corresponds to time-scale expansion.

The SOLA function duplicates a first frame x(Sₐ) from x(n) to y(n). An m^{th} frame of the input signal x(mSₐ+j)(0≦j≦N−1) is synchronized with and added to an adjacent time-scale modified signal y(mSₛ+j). In order to maximize a cross-correlation (defined by Equation 1 below) between a current frame x(mSₐ+_j) and a previous frame x(m(Sₐ−1)+j), the current frame x(mSₐ+j) is moved along the time-scale modified signal y(n) around a location of y(mSₛ) to find a location where a normalized cross-correlation coefficient Rₘ is a maximum. Therefore, the SOLA function allows a variable overlapping region in a frame in order to modify the time-scale of the input signal x(n) without affecting the pitch of the input signal x(n). The normalized cross-correlation coefficient Rₘ of the SOLA function in an m^{th} frame is obtained with respect to a frame arrangement offset k of an allowable range as shown in Equation 1.

$${R}_{m} ( k ) = \frac{{\sum }_{j = 0}^{L - 1} y ( {mS}_{s} + k + j ) x ( {mS}_{a} + j )}{\sqrt{{\sum }_{j = 0}^{L - 1} {x}^{2} ( {mS}_{a} + j ) {\sum }_{j = 0}^{L - 1} {y}^{2} ( {mS}_{s} + k + j )}} for - \frac{N}{2} \leq k \leq \frac{N}{2} \qquad [ Equation 1 ]$$

Here, x(n) denotes the input signal for the time-scale modification, y(n) denotes the time-scale modified signal, m denotes a number of frames, and L denotes a length of a region in which x(n) and y(n) overlap.

Therefore, once Rₘ is determined, y(n) is updated as shown in Equation 2.

$$y ( {mS}_{s} + {k}_{m} + j ) = \{ \begin{matrix}( 1 - f ( j ) ) y ( {mS}_{s} + {k}_{m} + j ) + f ( j ) x ( {mS}_{a} + j ) & for 0 \leq j \leq {L}_{m} - 1 \\ x ( {mS}_{a} + j ) & for {L}_{m} \leq j \leq N - 1\end{matrix} \qquad [ Equation 2 ]$$

Here, Lₘ denotes an overlapping region between two signals, in which the determined Rₘ is included, and ƒ(j) denotes a weighting function resulting in 0≦ƒ(j)≦1.

Therefore, the time-scale compression and expansion of an original signal can be performed using the SOLA method as illustrated in FIGS. 8A through 8C. That is, FIG. 8A illustrates an original signal (a solid line) and first and second overlapping segments (dotted lines), FIG. 8B is a waveform diagram illustrating the time-scale expansion of the original signal using synchronized segments that are overlapping, and FIG. 8C is a waveform diagram illustrating the time-scale compression of the original signal using the synchronized segments that are overlapping. Thus, the SOLA method herein described can be used by the pre-processor 110 of FIG. 1 and/or the post-processor 430 of FIG. 4 to compress and/or expand the time scale of the signal, respectively. Additionally, the present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet).

As described above, according to embodiments of the present general inventive concept, by reducing a number of similar frames in an audio signal using time-scale modification, an excellent quality audio signal can be reproduced without the loss of a high frequency band.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio encoding/decoding method, comprising:
encoding audio data of an input audio signal by determining a similarity between frames of the input audio signal, compressing the input audio signal with respect to a time-scale, and generating a frame time-scale modification flag; and
decoding the audio data from the encoded audio signal based on the frame time-scale modification flag.

2. The method of claim 1, wherein the encoding of the input audio signal comprises:
pre-processing the input audio signal by determining the similarity between frames of the input audio signal, compressing the input audio signal on the time-scale, and generating the frame time-scale modification flag;
encoding the audio data of the pre-processed audio signal based on a psychoacoustic model; and
converting the frame time-scale modification flag and the encoded audio data into a bitstream.

3. The method of claim 2, wherein the pre-processing of the input audio signal comprises performing a synchronized overlap and add process according to:
$${R}_{m} ( k ) = \frac{{\sum }_{j = 0}^{L - 1} y ( {mS}_{s} + k + j ) x ( {mS}_{a} + j )}{\sqrt{{\sum }_{j = 0}^{L - 1} {x}^{2} ( {mS}_{a} + j ) {\sum }_{j = 0}^{L - 1} {y}^{2} ( {mS}_{s} + k + j )}} for - \frac{N}{2} \leq k \leq \frac{N}{2}$$
where Rₘ comprises a cross-correlation coefficient, x(n) comprises an input signal, y(n) comprises a time-scale modified signal y(n), Sₐ comprises a gap between frames of the input signal x(n), Sₛ comprises a gap between frames of the time-scale modified signal y(n), N comprises a length of a frame, and L comprises an overlapping region between the input signal x(n) and the time scale modified signal y(n).

4. The method of claim 2, wherein the pre-processing comprises:
determining the similarity between frames of the input audio signal, and if the similarity between a previous frame and a current frame is greater than a predetermined value, generating the frame time-scale modification flag; and
compressing the current frame with respect to the time-scale based on the generated frame time-scale modification flag.

5. The method of claim 4, wherein the determining of the similarity comprises:
analyzing a frequency component for each frame of the input audio signal;
calculating an analyzed frequency component difference between the previous frame and the current frame; and
determining that a similarity exists between the previous frame and the current frame if the frequency component difference is less than a predetermined threshold, and determining that no similarity exists between the previous frame and the current frame if the frequency component difference is greater than the predetermined threshold.

6. The method of claim 2, wherein the pre-processing comprises:
determining the similarity between frames of the input audio signal; and
skipping a current frame if the similarity between a previous frame and a current frame is greater than a predetermined value.

7. The method of claim 6, wherein the determining of the similarity comprises:
analyzing a frequency component for each frame of the input audio signal;
calculating an analyzed frequency component difference between the previous frame and the current frame; and
determining that a similarity exists between the previous frame and the current frame if the frequency component difference is less than a predetermined threshold, and determining that no similarity exists between the previous frame and the current frame if the frequency component difference is greater than the predetermined threshold.

8. The method of claim 2, wherein the encoding of the input audio signal comprises:
splitting input audio samples into a plurality of subbands using polyphase banks;
determining bit allocation information for each subband according to a masking effect and an audible limitation of psychoacoustics of the plurality of subbands; and
allocating bits to the plurality of subbands based on the determined bit allocation information for each subband.

9. The method of claim 1, wherein the decoding of the encoded audio signal comprises:
separating the frame time-scale modification flag and the audio data from an input bitstream;
decoding the separated audio data using a predetermined decoding algorithm; and
expanding the decoded audio signal by performing time-scale expansion when the separated frame time-scale modification flag is enabled.

10. A method of encoding audio data, the method comprising:
receiving an input signal having data that is divided into a plurality of time frames;
determining similarities among the plurality of frames of the input signal and generating a time-scale modify flag when a current frame is determined to be similar to a previous frame to indicate that at least some data of the current frame is not to be encoded;
compressing the data of the plurality of frames with respect to a time scale according to whether the time-scale modify flag is generated; and
forming a bitstream including the compressed data and one or more occurrences of the time-scale modify flag.

11. The method of claim 10, wherein the compressing of the data of the plurality of frames comprises skipping a current frame when a corresponding time-scale modify flag is generated.

12. The method of claim 10, wherein the determining of the similarities comprises comparing frequency components of a plurality of frequency subbands of input signal.

13. The method of claim 12, wherein the comparing of the frequency components comprises calculating a frequency component difference between a current frame and a previous frame and comparing the calculated frequency component difference to a similarity threshold.

14. The method of claim 10, wherein the forming of the bitstream comprises:
encoding the compressed data according to a psychoacoustic model; and
packing the encoded data, the one or more occurrences of the time-scale modify flag, header information, and side information into the bitstream.

15. The method of claim 10, wherein the compressing of the data comprises increasing a signal reproduction rate.

16. The method of claim 10, wherein the compressing of the data of the plurality of frames comprises overlapping and adding pitch durations of the input signal.

17. A method of encoding audio data, the method comprising:
performing a time scale modification operation on an audio signal to increase a signal reproduction rate of the audio signal by compressing the audio signal with respect to a time scale; and
encoding the compressed audio signal by allocating bits according to a psychoacoustic model.

18. A method of decoding audio data, the method comprising:
receiving an input bitstream and extracting audio data and one or more time-scale modify flags therefrom;
decoding the audio data from the input bitstream to obtain an audio signal; and
expanding the decoded audio signal with respect to a time scale according to the one or more time scale modify flags received with the audio data.

19. The method of claim 18, wherein the one or more time scale modify flags indicate one or more frames of the audio signal that are compressed with respect to the time scale during a previous encoding operation.

20. The method of claim 18, wherein the one or more time scale modify flags indicate one or more frames of the audio signal that are skipped during a previous encoding operation.

21. An audio encoding/decoding apparatus, comprising:
a pre-processor to compress an input audio signal on a time-scale based on a similarity between frames of the input audio signal and to generate a frame time-scale modification flag accordingly;
an encoder to encode the compressed audio signal into audio data based on a psychoacoustic model;
a packing unit to convert the frame time-scale modification flag generated by the pre-processor and the audio data encoded by the encoder into a bitstream;
an unpacking unit to separate the frame time-scale modification flag and the audio data from the bitstream received from the packing unit;
a decoder to decode the audio data separated by the unpacking unit into a decoded audio signal using a predetermined decoding algorithm; and
a post-processor to expand the audio signal decoded by the decoder by expanding the time-scale when the frame time-scale modification flag separated by the unpacking unit is enabled.

22. The apparatus of claim 21, wherein the pre-processor comprises:
a frame similarity determiner to analyze a frequency component for each frame of the input audio signal, to determine the similarity between frames based on a difference between the frequency components, and to generate the frame time-scale modification flag if the similarity between a previous frame and a current frame is greater than a predetermined value; and
a time-scale modifier to compress the current frame with respect to the time-scale according to whether the frame time-scale modification flag is generated by the frame similarity determiner.

23. An apparatus to encode audio data, comprising:
a pre-processor to receive an input signal having data that is divided into a plurality of frames, the pre-processor comprising:
a frame similarity determiner to determine similarities among the plurality of frames of the input signal and to generate a time-scale modify flag when a current frame is determined to be similar to a previous frame to indicate that at least some data of the current frame is not to be encoded, and
a time scale modifier to compress the data of the plurality of frames with respect to a time scale according to whether the time-scale modify flag is generated; and
an encoder to form a bitstream including the compressed data and one or more occurrences of the time-scale modify flag.

24. The apparatus of claim 23, wherein the time scale modifier comprises a frame skipping unit to skip a current frame when a corresponding time-scale modify flag is received from the frame similarity determiner.

25. The apparatus of claim 23, wherein the frame similarity determiner compares frequency components of a plurality of frequency subbands of the input signal.

26. The apparatus of claim 25, wherein the frame similarity determiner compares the frequency components by calculating a frequency component difference between a current frame and a previous frame and comparing the calculated frequency component difference to a similarity threshold.

27. The apparatus of claim 23, wherein the encoder comprises:
a bit allocator to allocate bits to encode the compressed data according to a psychoacoustic model; and
a packing unit to pack the encoded data, the one or more occurrences of the time-scale modify flag, header information, and side information into the bitstream.

28. The apparatus of claim 23, wherein the time scale modifier increases a signal reproduction rate.

29. An apparatus to encode audio data, comprising:
a pre-processor to perform a time scale modification operation on an audio signal to increase a signal reproduction rate of the audio signal by compressing the audio signal with respect to a time scale; and
an encoding unit to encode the compressed audio signal by allocating bits according to a psychoacoustic model.

30. An apparatus to decode audio data, comprising:
an unpacking unit to receive an input bitstream and to extract audio data and one or more time-scale modify flags therefrom;
a decoder to decode the audio data from the input bitstream to obtain an audio signal; and
a post-processor to expand the decoded audio signal with respect to a time scale according to the one or more time scale modify flags received with the audio data.

31. The apparatus of claim 30, wherein the one or more time scale modify flags indicate one or more frames of the audio signal that are compressed with respect to the time scale during a previous encoding operation.

32. The apparatus of claim 30, wherein the one or more time scale modify flags indicate one or more frames of the audio signal that are skipped during a previous encoding operation.

33. A computer readable medium containing executable code to encode and/or decode audio signal data, the medium comprising:
a first executable code to encode audio data of an input audio signal by determining a similarity between frames of the input audio signal, compressing the input audio signal with respect to a time-scale, and generating a frame time-scale modification flag accordingly; and
a second executable code to decode the audio data from the encoded audio signal based on the frame time-scale modification flag.
